(19) United States
(12) Patent Application Publication
(10) Pub. No.: US 2024/0362335 A1
(43) Pub. Date: Oct. 31, 2024

(54) MALWARE ANALYSIS USING GROUP TESTING

(71) Applicant: Avast Software s.r.o., Prague 4 (CZ)

(72) Inventors: Fabrizio Biondi, Granarolo dell'Emilia (CZ); Andrew Gardner, Praha 4 (CZ)

(73) Assignee: Avast Software s.r.o., Prague 4 (CZ)

(21) Appl. No.: 18/306,861

(22) Filed: Apr. 25, 2023

(51) Int. Cl. G06F 21/57; G06F 21/53

(52) U.S. Cl. CPC G06F 21/577; G06F 21/53; G06F 2221/033

(57) ABSTRACT

Malicious activity is identified in a plurality of sequences of computer instructions by identifying a plurality of sequences of computer instructions of interest, and assigning the plurality of sequences of computer instructions into two or more groups. A virtual machine sandbox is executed for each of the two or more groups, and each of the plurality of sequences of computer instructions is executed in the virtual machine sandbox into which the sequence of computer instructions has been assigned. Behavior of the executing instruction sequences is monitored, and is used to determine whether each of the groups has at least one executed sequence of computer instructions that is likely malicious.

### FIELD

The invention relates generally to detection of malicious activity in computer systems, and more specifically to malware analysis using group testing.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users or criminals to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

For example, antivirus or antimalware software compares a data set of known malicious executable code to executable code installed on a computer or loaded into the computer's memory, and blocks execution of code determined likely to be malicious. But, identifying a match between known malicious code and code on an end user's computer can be challenging, especially as malware developers seek to hide or change the way malware is encoded to avoid detection. Common behavioral methods of detecting malware such as executing software instructions being tested in a virtual machine or “sandbox” provides useful information on the software instructions' malicious or benign behavior, but requires significant overhead to launch a virtual machine instance and test each software instruction sequence. Because a typical anti-malware company may gather hundreds of thousands to millions of code samples of interest per day, even automated sandbox behavioral analysis has tremendous overhead.

It is therefore desirable to manage analysis of executing code on a computerized system to provide more effective and efficient detection of malware and other vulnerabilities.

### SUMMARY

In one example, malicious activity is identified in a plurality of sequences of computer instructions by identifying a plurality of sequences of computer instructions of interest, and assigning the plurality of sequences of computer instructions into two or more groups. A virtual machine sandbox is executed for each of the two or more groups, and each of the plurality of sequences of computer instructions is executed in the virtual machine sandbox into which the sequence of computer instructions has been assigned. Behavior of the executing instruction sequences is monitored, and is used to determine whether each of the groups has at least one executed sequence of computer instructions that is likely malicious.

In a further example, static analysis-including analysis based on contextual information—is performed on the instruction sequences of interest, and is used to control one or more group testing parameters of the respective computer instruction sequences or groups. In one such example, static analysis is used to adjust time spent executing each of the plurality of sequences of computer instructions in the virtual machine sandbox into which the sequence of computer instructions has been assigned based on the static analysis. In another such example, the plurality of sequences of computer instructions are assigned into two or more groups based on the static analysis, such that sequences of computer instructions determined more likely to be malicious using static analysis are assigned to smaller groups of sequences of computer instructions than sequences of computer instructions determined more likely to be benign.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a malware evaluation system in a networked environment, consistent with an example embodiment

FIG. 2 shows an example of group testing a set of instruction sequence samples, consistent with an example embodiment

FIG. 3 is a flowchart of a method of group testing instruction sequence samples for malicious behavior, consistent with an example embodiment.

FIG. 4 is a flowchart of a method of using static analysis to adjust parameters of group testing instruction sequences for malicious behavior, consistent with an example embodiment.

FIG. 5 is a computerized malware evaluation system, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to a corporate computer to steal, delete, or change information, or to encrypt the information and hold it for ransom via “ransomware.” Computer applications, smartphone apps, and even documents such as Microsoft Word documents containing macros are all frequently infected with malware of various types, and users rely on tools such as antivirus software or other malware protection tools to protect their computerized devices from harm.

In a typical home computer or corporate computing environment, firewalls inspect and restrict the types of communication that can occur over a network, antivirus programs prevent known malicious code from being loaded or executed on a computer system, and malware detection programs detect known malicious code such as remailers, keystroke loggers, and other software that is designed to perform undesired operations such as stealing information from a computer or using the computer for unintended purposes.

Detection of malicious code was first done by comparing known malicious code to code that is installed or executed on a computer system, such as where a segment of malicious code that infects an executable file could be identified and execution of the executable could be stopped. But, malware developers frequently change the way the code itself is expressed, using obfuscation techniques to hide malicious code from antimalware (and antivirus) software. Some sophisticated antimalware software tries to block malicious code by observing the behavior of code installed or executing on a computer, and comparing it to behavior of code known to be malicious.

Identifying behavioral patterns of code known to be malicious and comparing these behavioral patterns to code on the user's computer is a complex task, and is both very computationally expensive and relies on differentiation between malicious and benign behavior in both the known malware and user's computer. For example, collecting snapshots of behavior observed on millions of computers each day and finding patterns of malicious behavior in the code requires significant computational resources and efficient characterization of the behavioral data. In one example, collected program instructions are executed on a virtual machine “sandbox” where the code can be executed safely without causing damage to a working computing environment. Malicious behavior is constrained to the virtual machine sandbox environment, and can be readily controlled and observed by malware researchers.

But, launching a virtual machine sandbox for each program instruction sequence of interest can take vast amounts of time and computational resources, and is a relatively inefficient way of analyzing hundreds of thousands or millions of instruction sequences of interest. A need therefore exists for more efficient analysis of executing computer instruction sequences of interest on a computerized system to provide more efficient detection of malware and other vulnerabilities.

Some examples described herein therefore seek to improve the performance of malware detection in computer instruction sequences of interest by using methods such as group testing, and careful assignment of instruction sequences of interest to groups using static analysis, including analysis based on contextual information. In one such example, malicious instruction sequences are identified by assigning a plurality of sequences of computer instructions of interest to different groups and executing a virtual machine sandbox for each group. The instruction sequences of interest assigned to each group are then executed within the virtual machine sandbox, and their behavior is monitored for malicious activity. If no malicious activity is detected in a group, all computer instruction sequences within that group can be considered clean or benign. If malicious behavior is observed within a group, that group can be further divided or reassigned to a group with instruction sequences from other groups having likely malicious computer instruction sequences using various group testing algorithms. By iteratively repeating this process, likely malicious computer instruction sequences can be identified using far fewer virtual machine sandbox instances than if each instruction sequence of interest were tested in its own sandbox.

In a further example, methods such as static analysis of the computer instruction sequences of interest can be used to improve the efficiency of the group testing. In one example, computer instruction sequences that appear to be possibly or likely malicious using static testing are assigned to a group that will execute a virtual machine sandbox environment for a longer time, improving the chances of detecting malicious activity from the executing instruction sequence of interest. In another example, the potentially or likely malicious instruction sequence of interest is assigned to a group having fewer assigned instruction sequences, speeding the group testing process of identifying individual malicious instruction sequences by requiring fewer virtual machine sandbox testing iterations.

Methods such as those described herein can improve the efficiency and the effectiveness of searching computer instruction sequences of interest for malicious behavior by dramatically reducing the number of virtual machine sandboxes that are launched, improving the cost, speed, and effectiveness of malware detection. Computer security companies can therefore dedicate a greater portion of their resources to other tasks, such as analyzing suspicious and relevant instruction sequences of interest. Further, rapid detection of new malware can improve a security company's response time to new threats, reducing the new threat's impact on the security company's customers.

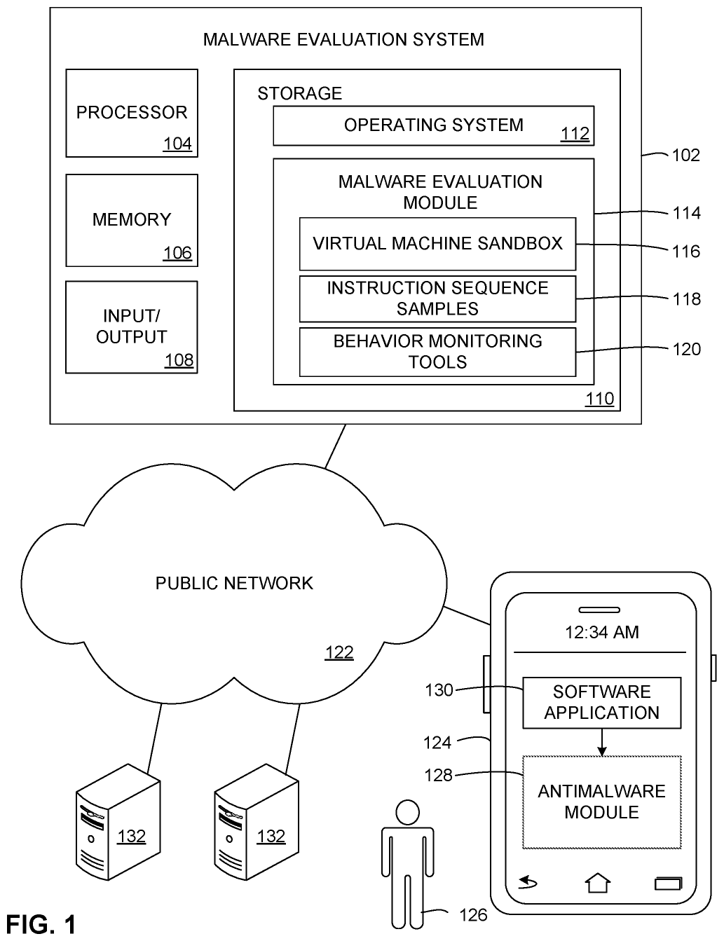

FIG. 1 shows a malware evaluation system in a networked environment, consistent with an example embodiment. Here, a malware evaluation system 102 comprises a processor 104, memory 106, input/output elements 108, and storage 110. Storage 110 includes an operating system 112 and malware evaluation module 114 that is operable to use group testing to evaluate computer instruction sequences of interest for malicious behavior. The malware evaluation module 114 further comprises virtual machine sandboxes 116 operable to execute an isolated operating system environment in which potentially malicious computer instruction sequences can be safely executed and observed. Instruction sample sequences 118 are gathered from various sources such as end user computing devices, including smartphone 124 and computers 132 via a public network 122 such as the Internet. Behavior monitoring tools 120 enable a malware researcher to monitor behavior of the instruction sequence samples 118 when executing in an assigned virtual machine sandbox 116, and in further examples provide other tools such as the ability to step through instructions one at a time, to isolate one particular process or thread, and to pre-identify or pre-sort instruction sequence samples using static, non-behavioral analysis of the instruction sequence samples. When the malware evaluation module 114 identifies a computer instruction sequence that is likely malicious, it flags the instruction sequence for further research or evaluation, sends a malware signature to end user systems such as computers 132 and smartphone 124, or performs other such actions to aid in future detection of the identified malware.

In a more detailed example, a user 126 operates smart phone 124 (or another computerized device such as computers 132), including installing and execution software applications such as 130. When a software application is installed or executed, antimalware module 128 monitors the computer instruction sequences within the software application for potentially malicious activity, including in this example activity not known to be malicious but that resembles behaviors and/or instruction sequences previously identified as malicious. When a computer instruction sequence of interest is identified in smartphone 124, the antimalware module 128 sends the instruction sequence to a malware evaluation system 102 for further investigation.

The malware evaluation system 102 in this example receives hundreds of thousands to millions of instruction sequence samples 118 of interest per day, and desirably makes efficient use of both computing power and malware researcher time in evaluating the behavior of the instruction sequence samples when executed.

When it is time to evaluate the gathered instruction sequence samples 118, such as when a threshold time since the last evaluations has passed or a certain number of instruction sequence samples have been received, the instruction sequence samples are divided into groups. A virtual machine sandbox 116 is then launched for each group (although not necessarily all at the same time), and the groups of instruction sequence samples are executed on their respective virtual machine sandboxes. Behavior monitoring tools 120 allow monitoring the behavior of the executing instruction sequences, such as watching for remote network access, watching for encryption functions, and watching for cryptocurrency mining operations. The monitoring is automated in some examples, while other examples involve interaction with a malware researcher while the instruction sequence samples are executing such as notifying the malware researcher of instruction sequence behavior of interest and receiving commands to step through the instruction sequence from the malware researcher.

Different group testing algorithms and methods are used in different examples, but most examples will involve multiple rounds of forming new groups from the instruction sequence samples under test and repeating testing of the grouped instruction sequence samples several times to determine which instruction sequence samples are possibly or likely malicious. Some such algorithms are adaptive, and grouping and testing is based on knowledge gained during prior rounds of grouping and testing instruction sequence samples, while other algorithms are non-adaptive and do not rely on the results of prior rounds to determine grouping for subsequent rounds of testing.

When the group testing process is complete, any instruction sequences identified as possibly or likely malicious are flagged, such as for manual review by a malware researcher, for further automated testing to gather more information about the instruction sequence, and/or are identified to antimalware modules 128 on end user devices such as smartphone 124 as potentially malicious.

Methods such as these greatly reduce the number of virtual machine sandboxes that must be launched to analyze the hundreds of thousands to millions of instruction sequence samples of interest stored at 118 in some examples, and provide for the classification of large numbers of samples with a comparatively small number of sandboxes. Improved computational efficiency and speed allow malware researchers to spend more resources on investigating instruction sequences that are suspected of having malicious behavior while improving the speed with which the malware researchers can respond to new and emerging threats.

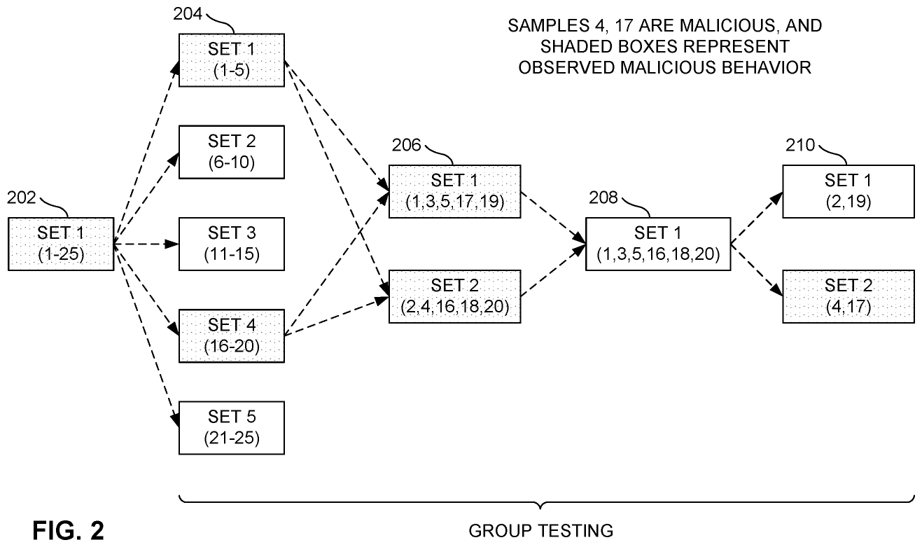

FIG. 2 shows an example of group testing a set of instruction sequence samples, consistent with an example embodiment. At 202, a sample set of computer instruction sequences of interest, numbered 1-25, are ready for test. Although prior methods would test each sample set of instructions in its own sandbox within a virtual machine, the method presented uses an example group testing method in which groups of instruction sequences are executed within the same sandbox to increase the speed and efficiency of malware determination.

The sample set of instruction sequences shown at 202 in this example contains two samples with malicious behavior, numbered 4 and 17 in the set of 1-25, but which are unknown until the group testing process is complete. The instruction sequences 1-25 are divided into five groups at 204, numbers as sets 1-25, with each set assigned five of the instruction set sequences as reflected in parenthesis. Upon launching five virtual machine sandboxes and executing the five instruction set sequences respectively assigned to each set, malicious behavior was determined present in only Set 1 and Set 5, with malicious behavior indicated in FIG. 2 by shaded set boxes.

Here, we are using and adaptive group testing algorithm that enables us to no longer test any samples within Set 2, Set 3, or Set 5, because no malicious activity was detected during execution of any of their assigned instruction sequences of interest. More specifically, after only five virtual machine sandbox launches we have eliminated 15 of the 25 samples as being possibly malicious, and are left with only the ten instruction sequences in Set 1 and Set 4 to test. Simply testing these ten remaining samples individually would result in a reduction of 40% in the number of virtual machine sandboxes launched to complete the testing, but this group testing example is adaptive in that it also uses knowledge of prior results to determine efficient future rounds of testing.

Because Set 1 and Set 4 each have malicious behavior in at least one of their instruction set sequences, the instruction set sequences from these sets are mixed at 206 and again tested in two new virtual machine sandboxes. In other examples, they may be broken up into a greater or lesser number of sets, and the number of samples per set need not remain static between round as it has through these steps of this example. Here, each of Set 1 and Set 2 are found to have malicious activity, and because it is most likely that there is only one malicious sequence per original set at 204 the algorithm guesses that we have either swapped malicious instruction sequences or swapped only clean sequences based on again having two sets with malicious behavior. We therefore test at 208 a set containing only instruction sequences that were not moved between the first and second sets found to be malicious at 204 and 206, resulting in a set with instruction sequences 1, 3, 5, 16, 18, and 20 at 208.

This set shown at 208 tests clean when evaluated in a virtual machine sandbox, so the adaptive group testing algorithm now knows there are at least two malicious instruction sequences based on two groups having malicious behavior at 204 and at 206, and they are among the instruction sets swapped between the upper and lower sets in FIG. 2 between the rounds of testing shown at 204 and 206. The algorithm therefore tests instruction set sequences 2, 4, 17, and 19, mixed from their original set assignments in the round of testing shown at 204. The resulting sets shown at 210 include Set 1 having instruction sequences 2 and 19, and Set 2 having instruction sequences 4 and 17. Because set 2 tests positive for malicious behavior and we know there are at least two malicious instruction sequences in the round of testing shown at 210, the adaptive algorithm concludes that Sets 4 and 17 are potentially or likely have malicious behavior and group testing is complete.

A total of ten virtual machine sandboxes have therefore been executed to test 25 different instruction sequences for malicious behavior, for an over 60% reduction in virtual machine sandboxes launched from testing each instruction set in the set of interest shown at 202 individually. In group testing examples with far greater numbers of samples and more sparse malicious behavior as are likely to be found in real-world examples, efficiency of even non-adaptive group testing algorithms such as multi-dimensional matrix algorithms and other combinatorial group testing algorithms can improve significantly on the efficiency of this simplified example.

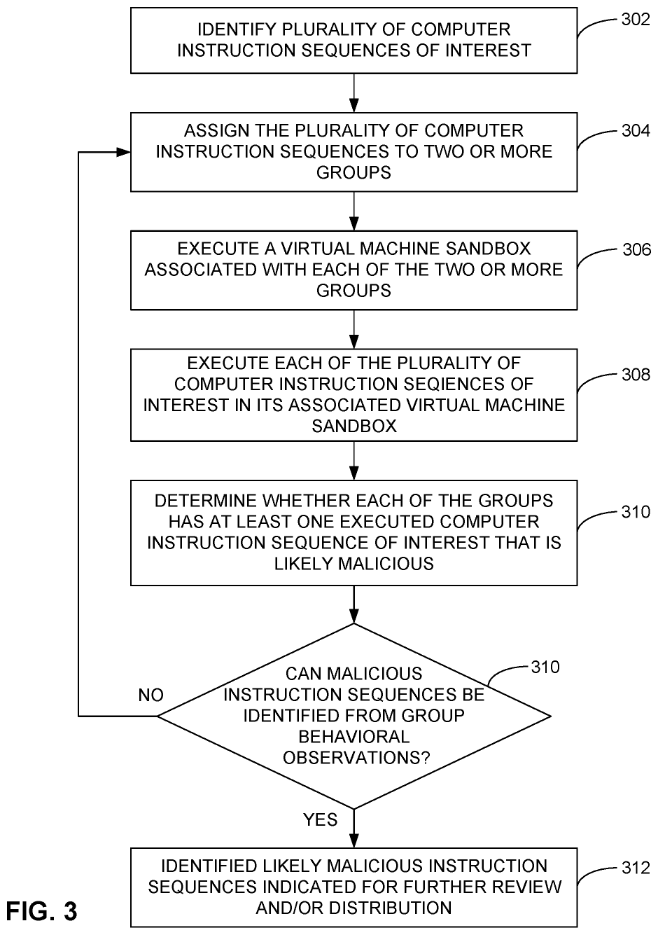

FIG. 3 is a flowchart of a method of group testing instruction sequence samples for malicious behavior, consistent with an example embodiment. At 302, a number of computer instruction sequences of interest are identified, such as by capturing instruction sequences that have suspicious characteristics or that are unknown in end user devices. The instruction sequences of interest are assigned to two or more groups for testing using a group testing algorithm at 204, and a virtual machine sandbox is launched for each of the groups at 306. The virtual machine sandbox in a more detailed example comprises an instance of an operating system environment that is isolated from other instances of the operating system, and in some examples has limited or controlled access to computer resources such as memory, nonvolatile storage, and network access that is available to other sandboxes or virtual machine instances. This prevents the computer instruction sequences of interest from harming the computer, while allowing it to run in a controlled environment so that malware researchers can monitor its behavior.

At 308, each of the plurality of computer instruction sequences of interest are executed in their associated virtual machines sandboxes. This includes in a more detailed example monitoring behavior of the executing software instruction sequences, such as by using automated tools to observe the instruction sequences' interaction with storage, network resources, spawning new processes or installing new software, and other such potentially malicious behavior of interest. In a further example, tools are provided for malware researchers to observe and/or control execution of the software sequences, such as displaying observed behavior of the instruction sequences and allowing the researcher to step through execution of the instructions in the sequence.

At 310, such automated processes and/or malware researcher determine whether each of the groups has at least one instruction sequence of interest that is likely malicious. If so, the group is marked malicious. This process of dividing computer instruction sequences of interest into groups and executing them as groups in virtual machine sandboxes continues as shown at 310, until the group testing algorithm has gathered sufficient information to determine which instruction sequences of interest are likely malicious. Once the likely malicious instruction sequences can be identified at 310, the identified likely malicious instruction sequences are indicated at 312 so that they can be further investigated by malware researchers, so that their signatures or behaviors can be shared with end user computers to help detect malware, or so that other appropriate action can be taken. Although the example shown here does not use a specific group testing algorithm, a variety of group testing algorithms such as adaptive group testing algorithms, non-adaptive group testing algorithms, combinatorial group testing algorithms, and other such algorithms are employed in various further embodiments.

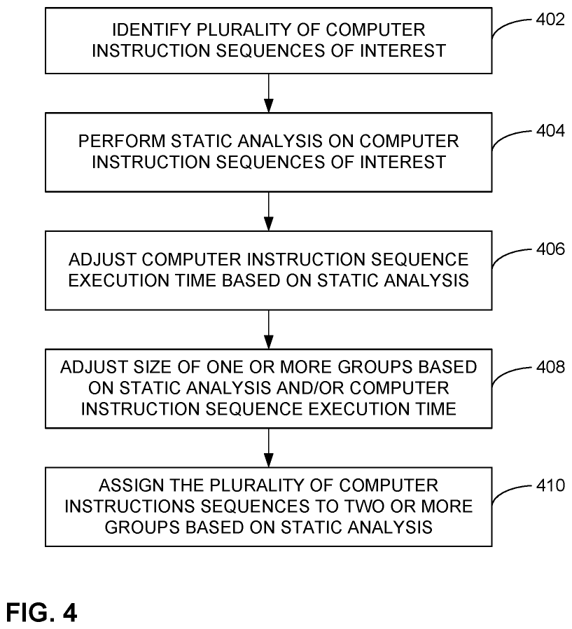

FIG. 4 is a flowchart of a method of using static analysis to adjust parameters of group testing instruction sequences for malicious behavior, consistent with an example embodiment. At 402, a set of computer instruction sequences of interest are identified, such as by using anti-malware software installed on user machines to report potentially malicious and/or unknown software to a malware evaluation system such as is shown at 102 in FIG. 1. The computer instruction sequences of interest are analyzed using static analysis methods, such as by examining the computer instruction sequences within the code and looking for certain patterns or actions without executing the code. Although static analysis is often not as useful in identifying malicious behavior as behavioral analysis (or monitoring the behavior of the computer instruction sequence as it executes), it can provide some indication of whether an instruction sequence is more likely to be malicious than other instruction sequences in the group of sequences identified at 402 for group testing.

At 406, the execution time for each instruction sequence is adjusted based on static analysis of the instruction sequence, such as executing computer instruction sequences determined to possibly be malicious through static analysis for 30 minutes while executing other instruction sequences for ten minutes. At 408, the size of one or more of the group testing groups is adjusted based on static analysis of the instruction sequence, such as placing computer instruction sequences determined to possibly be malicious through static analysis in smaller groups of instruction sequences than other instruction sequences to speed group testing isolation and identification of likely malicious computer instruction sequences. In a further example, computer instruction sequences determined to possibly be malicious through static analysis are deliberately distributed between different groups, minimizing the number of possibly malicious instruction sequences in each group to again speed group testing isolation and identification of likely malicious computer instruction sequences. Once adjustments based on static analysis of the computer instruction sequences such as these are made, the computer instruction sequences are assigned to groups at 410, and the group testing process as described in FIG. 3 proceeds.

Use of group testing such as is described in the examples presented here provides for a dramatic reduction in the number of virtual machine sandboxes that must be launched to test sets of computer instruction sequences of interest, thereby enabling resources to be spent elsewhere in improving detection and response to new malware threats. Further, faster identification of new malware can result in reduced impact to anti-malware customers, and a competitive advantage over other anti-malware providers. Also, use of sophisticated techniques such as using static analysis of computer sequences of interest to divide the sequences into groups can further improve the speed and efficiency with which new malware is identified, and again provide for faster response and for dedication of a greater portion of the antimalware researcher's limited resources to investigating computer instruction sequences more likely to be malware.

The computerized systems such as the malware evaluation system 102 of FIG. 1 used to perform group testing on instruction sequence samples of interest and the smart phone 124 that executes an end user antimalware module can take many forms, and are configured in various embodiments to perform the various functions described herein.

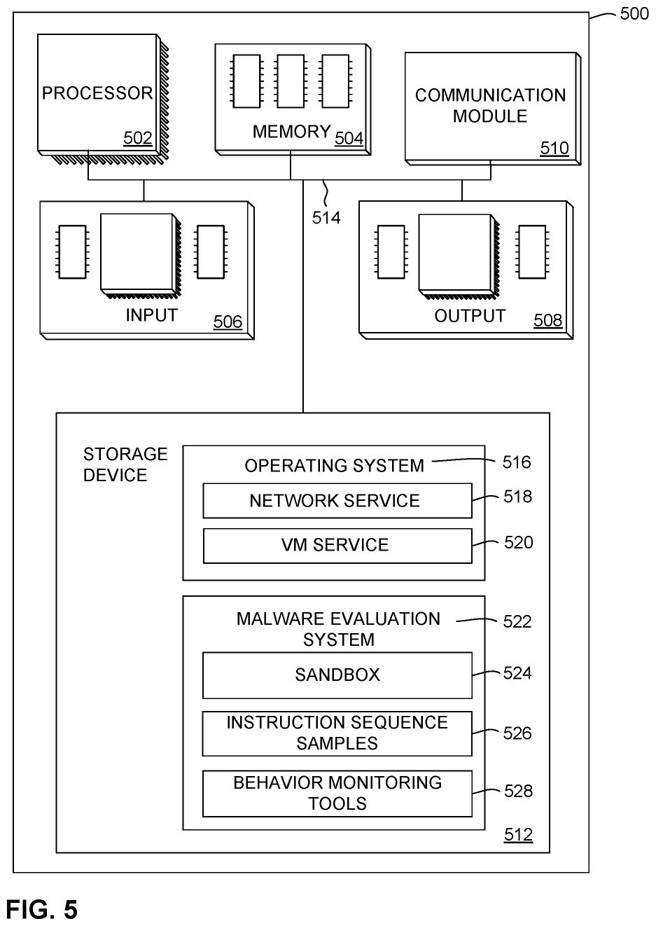

FIG. 5 is a computerized malware evaluation system, consistent with an example embodiment. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include all of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as malware evaluation system 522 are also stored on storage device 512, and are executable by computing device 500.

Each of components 502, 504, 506, 508, 510, and 512 may be interconnected (physically, communicatively, and/or operatively) for inter-component communications, such as via one or more communications channels 514. In some examples, communication channels 514 include a system bus, network connection, inter-processor communication network, or any other channel for communicating data. Applications such as malware evaluation system 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is known as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as malware evaluation system 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 510 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 500 uses communication module 510 to wirelessly communicate with an external device such as via public network 122 of FIG. 1.

Computing device 500 also includes in one example one or more input devices 506. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 508 include a speaker, a light-emitting diode (LED) display, a liquid crystal display (LCD), or any other type of device that can generate output to a user.

Computing device 500 may include operating system 516. Operating system 516, in some examples, controls the operation of components of computing device 500, and provides an interface from various applications such as malware evaluation system 522 to components of computing device 500. For example, operating system 516, in one example, facilitates the communication of various applications such as malware evaluation system 522 with processors 502, communication unit 510, storage device 512, input device 506, and output device 508. Applications such as malware evaluation system 522 may include program instructions and/or data that are executable by computing device 500. As one example, malware evaluation system 522 executes sandbox 524 using virtual machine service 520 to launch a virtual machine sandbox in which instruction sequence samples 526 are executed and their behavior observed such as by using behavior monitoring tools 528 to identify malicious sequences of program instructions. These and other program instructions or modules may include instructions that cause computing device 500 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of identifying malicious activity in a plurality of sequences of computer instructions, comprising:
identifying a plurality of sequences of computer instructions of interest;
assigning the plurality of sequences of computer instructions into two or more groups;
executing a virtual machine sandbox for each of the two or more groups;
executing each of the plurality of sequences of computer instructions in the virtual machine sandbox into which the sequence of computer instructions has been assigned;
determining whether each of the groups has at least one executed sequence of computer instructions that is likely malicious; and
upon determining whether each of the groups has at least one executed sequence of computer instructions that is likely malicious, isolating the groups having the sequence of computer instructions that is likely malicious.

2. The method of identifying malicious activity in a plurality of sequences of computer instructions of claim 1, further comprising:
assigning the plurality of sequences of computer instructions into two or more different groups;
executing a virtual machine sandbox for each of the two or more different groups;
executing each of the plurality of sequences of computer instructions in the virtual machine sandbox into which the sequence of computer instructions has been assigned; and
determining whether each of the different groups has at least one executed sequence of computer instructions that is likely malicious.

3. The method of identifying malicious activity in a plurality of sequences of computer instructions of claim 2, further comprising repeating the assigning the plurality of sequences of computer instructions, the executing a virtual machine sandbox, the executing each of the plurality of sequences of computer instructions, and the determining whether each of the different groups has at least one executed sequence of computer instructions that is likely malicious using different groupings of the plurality of sequences of computer instructions until it is possible to determine whether each of the plurality of sequences of computer instructions is likely malicious.

4. The method of identifying malicious activity in a plurality of sequences of computer instructions of claim 3, further comprising using a group testing algorithm to determine whether each of the plurality of sequences of computer instructions is likely malicious.

5. The method of identifying malicious activity in a plurality of sequences of computer instructions of claim 1, further comprising using group testing to determine whether each of the plurality of sequences of computer instructions is likely malicious.

6. The method of identifying malicious activity in a plurality of sequences of computer instructions of claim 5, wherein using group testing comprises using a nested group testing algorithm.

7. The method of identifying malicious activity in a plurality of sequences of computer instructions of claim 1, wherein determining whether each of the groups has at least one executed sequence of computer instructions that is likely malicious comprises analyzing a behavior of the sequences of computer instructions assigned to each of the virtual machine sandboxes.

8. The method of identifying malicious activity in a plurality of sequences of computer instructions of claim 1, further comprising identifying sequences of the plurality of the computer instruction sequences determined likely to be malicious to a user.

9. The method of identifying malicious activity in a plurality of sequences of computer instructions of claim 1, further comprising selecting the plurality of sequences of computer instructions of interest using static analysis.

10. The method of identifying malicious activity in a plurality of sequences of computer instructions of claim 9, further comprising adjusting time spent executing each of the plurality of sequences of computer instructions in the virtual machine sandbox into which the sequence of computer instructions has been assigned based on the static analysis.

11. The method of identifying malicious activity in a plurality of sequences of computer instructions of claim 9, further comprising adjusting assigning the plurality of sequences of computer instructions into two or more groups based on the static analysis, such that sequences of computer instructions determined more likely to be malicious using static analysis are assigned to smaller groups of sequences of computer instructions than sequences of computer instructions determined more likely to be benign.

12. A computerized system operable to identify malicious activity in a plurality of sequences of computer instructions, comprising:
a processor;
a storage; and
a stored set of program instructions stored in the storage and operable when executed on the processor to:
identify a plurality of sequences of computer instructions of interest;
assign the plurality of sequences of computer instructions into two or more groups;
execute a virtual machine sandbox for each of the two or more groups;
execute each of the plurality of sequences of computer instructions in the virtual machine sandbox into which the sequence of computer instructions has been assigned;
determine whether each of the groups has at least one executed sequence of computer instructions that is likely malicious; and
upon determining a sequence of computer instructions is likely malicious, isolating the sequence of computer instructions.

13. The computerized system of claim 12, the stored set of program instructions further operable when executed on the processor to:
assign the plurality of sequences of computer instructions into two or more different groups;
execute a virtual machine sandbox for each of the two or more different groups;
execute each of the plurality of sequences of computer instructions in the virtual machine sandbox into which the sequence of computer instructions has been assigned; and
determine whether each of the different groups has at least one executed sequence of computer instructions that is likely malicious.

14. The computerized system of claim 13, the stored set of program instructions further operable when executed on the processor to repeat, until it is possible to determine whether each of the plurality of sequences of computer instructions is likely malicious:
the assigning the plurality of sequences of computer instructions, the executing a virtual machine sandbox;
the executing each of the plurality of sequences of computer instructions; and
the determining whether each of the different groups has at least one executed sequence of computer instructions that is likely malicious using different groupings of the plurality of sequences of computer instructions.

15. The computerized system of claim 14, the stored set of program instructions further operable when executed on the processor to use a group testing algorithm to determine whether each of the plurality of sequences of computer instructions is likely malicious.

16. The computerized system of claim 12, the stored set of program instructions further operable when executed on the processor to use group testing to determine whether each of the plurality of sequences of computer instructions is likely malicious.

17. The computerized system of claim 16, wherein using group testing comprises using a nested group testing algorithm.

18. The computerized system of claim 12, wherein determining whether each of the groups has at least one executed sequence of computer instructions that is likely malicious comprises analyzing a behavior of the sequences of computer instructions assigned to each of the virtual machine sandboxes.

19. The computerized system of claim 12, the stored set of program instructions further operable when executed on the processor to use static analysis to adjust at least one of a time spent executing each of the plurality of sequences of computer instructions in the virtual machine sandbox into which the sequence of computer instructions has been assigned and assigning the plurality of sequences of computer instructions into two or more groups.

20. A method of identifying malicious activity in a plurality of sequences of computer instructions, comprising:
identifying a plurality of sequences of computer instructions of interest;
group testing the plurality of sequences of computer instructions in a plurality of virtual machine sandboxes, each of the plurality of sequences of computer instructions assigned to one of the plurality of virtual machines sandboxes;
evaluating a behavior of the group testing the plurality of sequences of computer instructions to identify one or more likely malicious sequences of computer instructions from among the plurality of sequences of computer instructions; and
upon determining a sequence of computer instructions is likely malicious, isolating the sequence of computer instructions.
